(19) United States
(12) Patent Application Publication
(10) Pub. No.: US 2023/0308493 A1
(43) Pub. Date: Sep. 28, 2023

(54) ACCESS METHOD AND DEVICE FOR MANAGING ACCESS TO A SECURE COMMUNICATION SESSION BETWEEN PARTICIPATING COMMUNICATION TERMINALS BY A REQUESTING COMMUNICATION TERMINAL

(71) Applicant: Orange, Issy-Les-Moulineaux (FR)

(72) Inventors: Richard Guignon, Chatillon Cedex (FR); Sébastien Poivre, Chatillon Cedex (FR); Nicolas Doisy, Chatillon Cedex (FR)

(21) Appl. No.: 18/001,950

(22) PCT Filed: Jun. 15, 2021
(86) PCT No.: PCT/FR2021/051063

§ 371 Date: Dec. 15, 2022

(30) Foreign Application Priority Data
Jun. 16, 2020 (FR) FR2006267

(51) Int. Cl. H04L 65/1093; H04W 12/08

(52) U.S. Cl. CPC H04L 65/1093; H04W 12/08

(57) ABSTRACT

A method for accessing a first secure communication session, referred to as a first session, in progress between participating communication terminals, referred to as participating terminals, by a requesting communication terminal, referred to as a requesting terminal. The access method includes: triggering an entry into the first session in progress of the requesting terminal on receipt of an acceptance from one of the participating terminals following a transmission of an access request message sent by the requesting terminal to at least one participating terminal of the first session. Hence, the requesting terminal will easily access the first secure communication session even if the requesting terminal does not follow the secure access procedure.

### CROSS-REFERENCE TO RELATED APPLICATIONS

This Application is a Section 371 National Stage Application of International Application No. PCT/FR2021/051063, filed Jun. 15, 2021, which is incorporated by reference in its entirety and published as WO 2021/255375 A1 on Dec. 23, 2021, not in English.

### TECHNICAL FIELD

The invention relates to access by a requesting access terminal to a secure communication session between participating communication terminals. A secure communication session is particularly understood to be a secure shared digital space, such as a conference call, a video conference, a virtual collaborative space, etc., which requires the use of access keys for each of the participating communication terminals.

### PRIOR ART

This type of secure communication session requires defining the list of participants before establishing the communication session: for example, identifying users and/or participating terminals. Thus, only the participants identified in the list will be authorized to establish and/or access the secure communication session.

In order to add an additional level of security, provision also can be made for the establishment of and/or the access to the secure communication session to also be dependent on the provision of a key by the participating communication terminal wishing to establish and/or to access the secure communication session, which key is particularly made up of an access code (such as a digital code, an alphanumeric code, also called password, a scheme, a code formed by a succession of images, etc.) and/or biometric data, etc.

Thus, only the previously registered participants can access this secure communication session and, if necessary, they must be able to present the access code in order to be granted access thereto.

However, a participant may have forgotten or lost their access code. This can prove to be problematic since the content (conversation, text documents, audio and/or video, etc.) that the participant was to share during this secure communication session then would not be accessible by the other participants. Furthermore, when the secure communication session allows at least one final content to be generated, this final content will be erroneous since it will not be in accordance with the content of the participant, who has not accessed the secure communication session but has only accessed the content shared by the participants who have accessed this session.

One solution would involve using a system for recovering the access code. However, if a system for recovering the access code is not provided in connection with the secure access to the secure communication session, or if the participant does not have the necessary means for recovering the access code (for example, if they do not have the cellphone receiving the temporary code via SMS with them), they will not be authorized to access the secure communication session.

Furthermore, the list of participants can be erroneous: with a person and/or a communication device having been omitted from the list. In this case as well, the omitted person will not be authorized to access the secure communication session: they therefore will not be able to contribute to the session, and if this session generates final content, this final content will be erroneous.

One solution, if such a person is aware of the communication session or has been notified by a participant of the communication session, would involve them contacting the person administering the list of participants and this person adding them to this list of participants in order to be able to access the secure communication session. However, this process is laborious since it firstly requires the omitted person being aware of the planned secure communication session, then the omitted person knowing the person administering the list of participants and having at least one means of contacting them (telephone number, email address, etc.), and the person administering the list of participants being contacted by the omitted person before the secure communication session in order to include them in the list of participants. Furthermore, even in this case, there is still a risk of error involving the omitted person being included in another list when the person administering the list manages several lists of participants in separate secure communication sessions.

### SUMMARY

One of the aims of the present invention is to address the disadvantages with respect to the prior art.

An aim of the invention is a method for accessing a first secure communication session, called first session, ongoing between participating communication terminals, called participating terminals, by a requesting communication terminal, called requesting terminal, the access method comprising:
triggering admission of the requesting terminal into the first ongoing session upon receipt of an acceptance from one of the participating terminals following a transmission of an access request message sent by the requesting terminal to at least one participating terminal of the first session.

Thus, the requesting terminal will easily access the first secure communication session even if the requesting terminal does not follow the secure access procedure (either that the requesting terminal is not a terminal of the list of participants authorized to access the first secure communication session, or that the requesting terminal does not have the access code to the first secure communication session). Furthermore, the requesting terminal accessing the first secure communication session will have access to the same exchanges carried out in the first session as any of the terminals participating in the first session.

Advantageously, the requesting terminal is separate from the participating terminals of the list of participating terminals associated with the first communication session.

Advantageously, the message, which once transmitted triggers access to the first session, comprises data entered by means of the requesting terminal.

Advantageously, the access method comprises:
receiving the acceptance from a participating terminal.

Thus, the acceptance is managed directly by the access method, avoiding overloading the network if the acceptance is first transmitted to the requesting terminal, which must then transmit it to the access method in order to trigger admission of the requesting terminal into the first session.

Advantageously, the access method comprises:
receiving an access request from a requesting terminal, the access request comprising the access request message; and
sending the access request message to at least one participating terminal of the first session.

Thus, the participating terminal has the elements that are required for transmitting the acceptance directly to the access method since the access request originates from the access method and not directly from the requesting terminal.

Furthermore, the requesting terminal can thus submit a request to access a first session even if they do not have means (telephone number, email address, user identifier in a social network, etc.) to directly contact a participant in the first session.

Advantageously, sending the access request message to the at least one participating terminal of the first session comprises one of the following steps:
broadcasting the message to all the participating terminals before the requesting terminal accesses the first session;
sending the message via asynchronous communication to at least one of the participating terminals;
sending the message to at least one participating terminal of the first session outside the first session.

Thus, irrespective of the mode of sending the access request message, the message is received by at least one participant and the requesting terminal is not aware of any exchanges that occurred in the first session before accessing this session following the acceptance.

Furthermore, broadcasting the message thus allows the possibility of acceptance of the access request to be maximized.

Moreover, with the message being sent outside the first session, a suspension of the exchanges in the first session thus can be avoided.

Advantageously, the access request message comprises at least one datum from among the following data:
a short audible warning datum;
an identifier associated with the requesting terminal;
an identifier associated with a terminal participating in the secure communication session;
an identifier of the first session to which the requesting terminal requests access;
a text, audio or video message of a user of the requesting terminal.

Advantageously, the access method comprises:
establishing, prior to triggering admission of the requesting terminal into the first session, a second synchronous communication session between the requesting terminal and one of the terminals participating in the first session following an establishment request from said one of the participating terminals following the transmission of an access request sent by the requesting terminal to at least one terminal participating in the communication session.

Advantageously, the access method comprises:
closing the second session upon implementation by the access method of one step from among the following steps:
   receiving an acceptance by the participating terminal of the second session;
   triggering admission of the requesting terminal into the first session.

Another aim of the invention is a method for requesting access to a first secure communication session, called first session, ongoing between participating communication terminals, called participating terminals, by a requesting communication terminal, called requesting terminal, the access request method comprising:
the requesting terminal being admitted into the first ongoing session, with said admission being triggered upon receipt of an acceptance from one of the participating terminals following the transmission of an access request sent by the requesting terminal to at least one participating terminal of the first session.

A further aim of the invention is a method for granting access to a first secure communication session, called first session, ongoing between participating communication terminals, called participating terminals, by a requesting communication terminal, called requesting terminal, the method for granting access comprising:
sending an acceptance from one of the participating terminals upon receipt of an access request message from the requesting terminal that is received by at least one participating terminal of the first session, with the sent acceptance triggering, upon receipt, admission of the requesting terminal into the first ongoing session.

Advantageously, according to one implementation of the invention, the various steps of the method according to the invention are implemented by software or by a computer program, with this software comprising software instructions intended to be executed by a data processor of a device forming part of a communication architecture and being designed to command the execution of the various steps of this method.

Therefore, the invention also relates to a program comprising program code instructions for executing the steps of the method for accessing a first secure communication session and/or the method for requesting access and/or the method for granting access when said program is executed by a processor.

This program can use any programming language and can be in the form of source code, object code or intermediate code between source code and object code, such as in a partially compiled format or in any other desirable format.

A further aim of the invention is a device for managing access to a first secure communication session, called first session, ongoing between participating communication terminals, called participating terminals, by a requesting communication terminal, called requesting terminal, the access management device comprising:
a controller capable of triggering admission of the requesting terminal into the first ongoing session upon receipt of an acceptance from one of the participating terminals following the transmission of an access request sent by the requesting terminal to at least one participating terminal of the first session.

A further aim of the invention is a requesting communication terminal, called requesting terminal, capable of requesting access to a first secure communication session, called first session, ongoing between participating terminals, called participating terminals, by a requesting communication terminal, called requesting terminal, the requesting terminal comprising:
a connector capable of admitting the requesting terminal into the first ongoing session, the connector being triggered upon receipt of an acceptance from one of the participating terminals following the transmission of an access request sent by the requesting terminal to at least one participating terminal of the first session.

Advantageously, the requesting terminal comprises:
a generator for generating an access request message capable of being sent by the requesting terminal to at least one participating terminal of the first session.

A further aim of the invention is a participating communication terminal, called participating terminal, participating in a first secure communication session, called first session, ongoing between participating communication terminals, called participating terminals, the participating terminal comprising:
a connector capable of establishing the first session between the participating terminal and at least one other participating terminal;
a validator capable of accepting access to the first session following the transmission of an access request sent by the requesting terminal to at least one participating terminal of the first session, the validator triggering admission of the requesting terminal into the first ongoing session.

Advantageously, the participating terminal comprises:
a connector capable of establishing a second synchronous communication session with the requesting terminal prior to acceptance by the validator.

### BRIEF DESCRIPTION OF THE DRAWINGS

The features and advantages of the invention will become more clearly apparent from reading the description, which is provided by way of an example, and from the corresponding figures, which show:

FIG. 1a, a simplified diagram of a method for managing access to a first secure communication session;

FIG. 1b, a simplified diagram of a method for accessing a first secure communication session by a requesting terminal according to the invention;

FIG. 2, a simplified diagram of a method for requesting access to a first secure communication session by a requesting terminal according to the invention;

FIG. 3, a simplified diagram of a method for granting access to a first secure communication session by a requesting terminal according to the invention,

FIG. 4, a simplified diagram of a diagram of exchanges in a communication architecture implementing a method for accessing a first secure communication session by a requesting terminal according to the invention;

FIG. 5, a simplified diagram of a communication architecture comprising a device for managing access to a first secure communication session by a requesting terminal according to the invention;

FIG. 6a, a simplified diagram of the use of an access management method in a particular use case of the invention;

FIG. 6b, a simplified diagram of the use of an optional first step of an access request method according to the invention in the use case of the invention of FIG. 6a;

FIG. 6c, a simplified diagram of the use of an optional second step of an access request method according to the invention in the use case of the invention of FIG. 6a;

FIG. 6d, a simplified diagram of the use of a method for granting access according to the invention in the use case of the invention of FIG. 6a;

FIG. 6e, a simplified diagram of the use of an optional second step of an access request method according to the invention in the use case of the invention of FIG. 6a.

### DESCRIPTION OF THE EMBODIMENTS

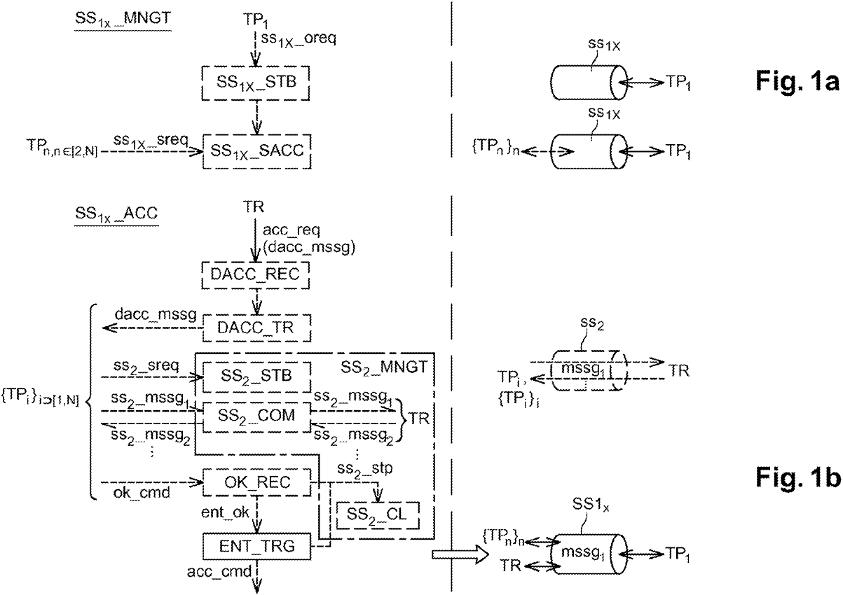

FIGS. 1a and 1b illustrate a method for managing access to a first secure communication session. FIG. 1a shows the access management method as it can exist in the prior art. FIG. 1b shows steps that can be integrated alone or in combination with the management method of FIG. 1a after the first session has been established.

FIG. 1a therefore illustrates a simplified diagram of a method for managing access to a first secure communication session.

The method SS_{1X}_MNGT for managing access to the first secure communication session comprises establishing SS_{1X_}STB the first secure communication session, in particular, following a request ss_{1X}_oreq to establish a secure communication session from a first participating communication terminal TP₁. The first participating communication terminal TP₁ is a communication terminal from the list of participants associated with the first secure communication session SS_{1X}. In this particular case, establishing SS_{1X_}STB the first session involves the first participating terminal TP₁ accessing the first session SS_{1X}.

In particular, the method SS_{1X}_MNGT for managing access comprises providing SS_{1X_}SACC secure access to the first session SS_{1X} to at least one participating terminal TP_{n,n∈[2,N]} from the list upon a subsequent request ss_{1X}_sreq for secure access to the first session by the at least one participating terminal TP_{n,n∈[2,N]} from the list.

After providing SS_{1X}_SACC secure access to the first session, the at least one participating terminal TPₙ accesses the first session SS_{1X}. The participating terminals TP₁, {TPₙ}ₙ accessing the first session SS_{1X} exchange data such as text messages, audio and/or video communications, content, etc., via this first session SS_{1X}.

The management method SS_{1X_}MNGT is implemented:
either by a separate management device of the participating terminals TPₙ, particularly implemented in a communication server of a communication network;
or by a management device implemented in the administrator terminal of the first session;
or by a management device implemented in the first participating terminal TP₁ that requested the establishment of the first session.

A particular embodiment of the management method SS_{1X}_MNGT is a program comprising program code instructions for executing the steps of the management method SS_{1X}_MNGT when said program is executed by a processor.

FIG. 1b illustrates a simplified diagram of a method for accessing a first secure communication session by a requesting terminal according to the invention.

The access method SS_{1X}_ACC is a method for accessing a first secure communication session SS_{1X}, called first session, ongoing between participating communications terminals {TRₙ}_{n=1...N}, called participating terminals, by a requesting communication terminal TR, called requesting terminal. The access method SS_{1X}_ACC comprises:
triggering ENT_TRG admission of the requesting terminal TR into the first ongoing session SS_{1X} upon receipt of an acceptance OK_REC from one of the participating terminals TPᵢ, following a transmission DAC_TR of an access request message dacc_mssg sent by the requesting terminal TR to at least one participating terminal {TPᵢ}_{i⊃}_{[1,N]}, of the first session.

In the case whereby access to the first secure communication session depends on belonging to a list of participating communication terminals associated with this first session for securing the first session (for example, preventing third party terminals, i.e., not belonging to this list, from accessing the exchanges made during this first session), the requesting terminal is particularly a communication terminal not belonging to the list of participants associated with the first secure communication session.

In the case whereby, in order to secure the first session, the participating terminals also must provide an access code in order to be authorized to access the first session, the requesting terminal also can be one of the participating terminals not having the access code during its request for access: either the user of the access terminal has forgotten the access code to the first session, or the access code previously recorded by the requesting terminal has been lost, or the access code is made available to the user of the requesting terminal on a communication terminal of the user of the requesting terminal that is separate from the requesting terminal and for which the request for access is currently unavailable to the user (in particular, the requesting terminal is a computer or a tablet, by means of which a user requests access to a collaborative space, for example, when they are traveling, this collaborative space sends an access code to the cellphone of the user. If the user has forgotten their cellphone, for example, at home, they will not be able to access this space).

In particular, the access method SS_{1X}_ACC comprises:
receiving OK_REC the acceptance from a participating terminal TPᵢ.

In particular, the access method SS_{1X}_ACC comprises:
receiving DACC_REC an access request acc_req from a requesting terminal TR, with the access request acc_req comprising the access request message dacc_mssg; and
sending DACC_TR the access request message dacc_mssg to at least one participating terminal {TPᵢ}_{i⊃[1,N]} of the first session.

In particular, sending DACC_TR the access request message to the at least one participating terminal of the first session SS_{1X} comprises:
broadcasting the message to all the participating terminals before the requesting terminal accesses the first session.

In an alternative embodiment, sending DACC_TR the access request message to the at least one participating terminal of the first session SS_{1X} comprises:
sending the message via asynchronous communication to at least one of the participating terminals.

In particular, sending DACC_TR the access request message to the at least one participating terminal of the first session SS_{1X} comprises:
sending the message to at least one participating terminal of the first session outside the first session.

In particular, the access request message dacc_mssg comprises at least one datum from among the following data:
a short audible warning datum, in particular a jingle, a bell, a warning tone, etc., such as an entrance gong, a doorbell chime, an audio datum corresponds to a “knock knock” on a door, etc.;
an identifier associated with the requesting terminal, such as a telephone number, an IMEI identifier, etc., a name, pseudonym or an email address of a user of the requesting terminal, etc.;
an identifier associated with a terminal participating in the secure communication session;
an identifier of the first session to which the requesting terminal requests access;
a text, audio or video message of a user of the requesting terminal.

In particular, the access method SS_{1X}_ACC comprises:
establishing SS₂_STB, before triggering ENT_TRG admission of the requesting terminal TR into the first session SS_{1X}, a second session SS₂ of synchronous communication between the requesting terminal TR and one of the participating terminals TPᵢ participating in the first session following an establishment request ss₂_req from said one of the participating terminals TPᵢ following the transmission DACC_TR of an access request message sent by the requesting terminal to at least one participating terminal of the communication session.

Then, the access method SS_{1X}_ACC particularly comprises implementing a communication SS₂_COM via the second session SS₂ between the participating terminal TPᵢ and the requesting terminal TR. They thus can particularly exchange messages ss₂_mssg₁, ss2_mssg2, etc. By virtue of these exchanges, the participating terminal TPᵢ and/or the user of the participating terminal TPᵢ can request additional information from the requesting terminal TR and/or the user of the requesting terminal TR. For example, when only the telephone number of the requesting terminal is provided by the access request message dacc_mssg, the participating terminal TPᵢ and/or its user can request the name of the user of the requesting terminal and any other information concerning the requesting terminal (technical capabilities, for example, in order to check its compatibility for accessing all or part of the first session: content, type of video communication, etc.) or concerning the user of the requesting terminal (affiliation with a school, an educational level, a company, a team, etc.; skills; age, etc.). The additional information will enable the user of the participating terminal TPᵢ or the participating terminal to implement a decision-making method for accepting or not accepting the access request from the requesting terminal.

In particular, the access method SS_{1X}_ACC comprises:
closing SS₂_CL the second session once the access method SS_{1X}_ACC implements a step from among the following steps:
receiving OK_REC an acceptance by the participating terminal TPᵢ of the second session SS₂;
triggering ENT_TRG admission of the requesting terminal TR into the first session SS_{1X}.

In particular, receiving OK_REC an acceptance or triggering ENT_TRG admission commands ss₂_stp the closure SS₂_CL of the second session.

In particular, the access method SS_{1X}_ACC comprises managing SS₂_MNGT a second communication session, called second session, separate from the first session. The second session SS₂ allows the requesting terminal TR to exchange with at least one participating terminal TPᵢ participating in the first session. Managing SS₂_MNGT a second session particularly comprises implementing the communication SS₂_COM via the second session SS₂ between the participating terminal TPᵢ and the requesting terminal TR.

In particular, managing SS₂_MNGT a second session comprises establishing SS₂_STB the second session and/or closing SS₂_CL the second session.

In particular, the steps of managing SS₂_MNGT a second session are implemented by the access method SS_{1X}_ACC.

After admission of the requesting terminal TR into the first session SS_{1X} has been triggered ENT_TRG, the requesting terminal TR accesses the first session SS_{1X}. The participating terminals TP₁, {TPₙ}ₙ and the requesting terminal TR accessing the first session SS_{1X} exchange data such as text messages, audio and/or video communications, content, etc., via this first session SS_{1X}.

In particular, the access method SS_{1X}_ACC is implemented in the access management method SS_{1X}_MNGT, in particular as illustrated in FIG. 1a, after the first session SS_{1X_}STB is established.

In a particular embodiment, the management method SS_{1X}_MNGT comprises creating SS_{1X}_CREA a first secure communication session prior to its establishment SS_{1X}_STB. The first session is created SS_{1X}_CREA upon a request from a participating terminal, called administrator terminal, of the first session, for example, the first participating terminal TP₁. During this creation step SS_{1X}_CREA, a list of participants is generated for which at least one identifier associated with each of the participants is provided by the administrator terminal. The identifier associated with a participant is particularly an identifier relating to a participating user having a communication terminal, by means of which they accessed the first session and/or a participating communication terminal. For example, when creating a first session for a conference call (audio conference or video conference), the identifiers of the participants are particularly the numbers of the participating telephones. In another example, when creating a first session for a collaborative space allowing both text and/or audio and/or video exchanges, in addition to the sharing of content, the identifiers of the participants are particularly email addresses of the participating users.

Once the first session is created, the management method SS_{1X}_MNGT establishes SS_{1X_}STB the first session either (first option) automatically on a session start date and/or time associated with the first session, or (second option) upon receipt by the management method SS_{1X}_MNGT of a first session request ss_{1X}_oreq from a first participating terminal TP₁, etc. The example of FIG. 1a corresponds to this second option.

In particular, the management method SS_{1X}_MNGT checks that the first session request ss_{1X_}oreq originates from the administrator terminal that helped to create the first session before establishing SS_{1X_}STB the first session.

Once the first session is established, the management method SS_{1X}_MNGT provides secure access SS_{1X}_SACC to the first session to a participating communication terminal, called participating terminal, upon a request for secure access ss_{1X}_sreq by a participating terminal TPₙ. The participating terminal is particularly understood to be a communication terminal, an identifier of which forms part of the list of participants associated with the first session or the user of which has an identifier that forms part of the list of participants associated with the first session.

In particular, granting access to the first session SS_{1X}_SACC comprises checking whether the communication terminal from which the secure access request ss_{1X}_sreq originates is a communication terminal relating to one of the participants from the list of participants. A terminal relating to one of the participants from the list of participants is understood to be a terminal corresponding to one of the terminals of the list of participants (when this list comprises identifiers of terminals) and/or a terminal available to a user corresponding to one of the users from the list of participants (when this list comprises identifiers relating to users: email address, name, pseudonym, etc.). It should be noted that the list of participants can also comprise both terminal identifiers (telephone number, IP address, IMEI, etc.) and user identifiers (email address, name, pseudonym, etc.).

In particular, the management method SS_{1X}_MNGT activates the access method SS_{1X}_ACC as soon as at least one participating terminal TPᵢ accesses the first session, or the administrator terminal when the first session is established SS_{1X}_STB upon its request SS_{1X}_oreq, or any other participating terminal TP_{n,} ₙ₌₁..._{N} when the first session is automatically established at a given time, for example.

Triggering ENT_TRG the admission of a requesting terminal TR implemented by the access method SS_{1X}_ACC results from an acceptance ok_cmd by a participating terminal TPᵢ after an access request message dacc_mssg is sent by the requesting terminal TR.

In particular, the access method SS₁x_ACC comprises receiving DACC_REC an access request acc_req(dacc_mssg) from the requesting terminal, then sending DACC_TR the access request message dacc_mssg to at least one participating terminal TPᵢ. Thus, if the requesting terminal TR does not know the participating terminals TPₙ, nor their users UPₙ, their access request nevertheless will be examined or even accepted and, in this case, it will nevertheless access the first session SS_{1X}.

Alternatively, subject to the requesting terminal TR knowing at least one participating terminal TP₁ or a participating user UPᵢ (provided with a participating terminal TPᵢ) participating in the first session SS_{1X}, the access request acc_req is sent directly from the requesting terminal TR to the participating terminal TPᵢ or to the participating user UPᵢ (provided with a participating terminal TPᵢ). Furthermore, the participating terminal TPᵢ accepting the access request directly or indirectly commands ok_cmd the triggering ENT_TRG, by the access method SS_{1X}_ACC, of the admission of the requesting terminal TR into the first session SS_{1X}.

In particular, the triggering ENT_TRG is directly commanded ok_cmd by the participating terminal TPᵢ. Alternatively, the access method SS_{1X}_ACC comprises receiving OK_REC an acceptance ok_cmd from the participating terminal TPᵢ. The reception of an acceptance OK_REC commands ent_ok the triggering ENT_TRG of admission into the first session.

Optionally, the acceptance ok_cmd comprises, in addition to validating the admission of the requesting terminal into the first session SS_{1X} (for example, in the form of an identifier associated with the requesting terminal and, optionally, of an identifier of the first session), data relating to the granted access. For example, access to the first session SS₁x for the requesting terminal TR can be:
total, i.e., identical to the accesses granted to the other participants;
access with a predefined category, such as the guest category, or n^{th} category (in particular when the participants are themselves already divided into several categories for different forms of access: access by:
   text and/or audio and/or video exchanges; and/or
   reading, and/or writing content; and/or
   sharing or not sharing content);
limited (access by text exchange only, and listening/viewing the exchanges of the participating terminals and/or read access to the shared content, without document sharing by the requesting terminal), etc.

In a particular embodiment, optionally supplementing the previous specific embodiment, the one or more participating terminal(s) TPᵢ that received the access request message dacc_mssg from the requesting terminal TR can synchronously or asynchronously exchange with the requesting terminal TR prior to the acceptance ok_cmd. The one or more participating terminal(s) TPᵢ can particularly send a first message mssg1 to the requesting terminal.

In particular, the first message mssg1 of the one or more participating terminal(s) TPᵢ comprises a request relating to the requesting terminal TR, in particular to its capabilities in terms of peripherals (camera, microphone, screen size, etc.), in terms of memory, in terms of processing (software, plug-in, etc.), etc., and/or to the user of the requesting terminal (identity, location, age, skill(s), skill(s) level, etc.). In this case, the requesting terminal TR can send a second message mssg2 in return or in response that particularly comprises one or more response(s) to the requests of the first message mssg1. The exchange can continue with additional messages between the one or more participating terminal(s) TPᵢ and the requesting terminal TR. In particular, the exchange is particularly closed by the acceptance ok_cmd by one of the participating terminals TPᵢ exchanging with the requesting terminal TR.

In particular, one of the messages mssg originating from the participating terminal TPᵢ comprises the acceptance command ok_cmd. In this latter case, the requesting terminal TR commands ok_cmd the triggering ENT_TRG of its admission into the first session by sending the acceptance command contained in the first message mssg1 to the access method SS_{1X}_ACC.

A particular embodiment of the access method SS_{1X}_ACC is a program comprising program code instructions for executing the steps of the access method SS_{1X}_ACC when said program is executed by a processor.

A particular embodiment of the management method SS_{1X}_MNGT is a program comprising program code instructions for executing the steps of the management method SS_{1X}_MNGT and of the access method SS_{1X}_ACC when said program is executed by a processor.

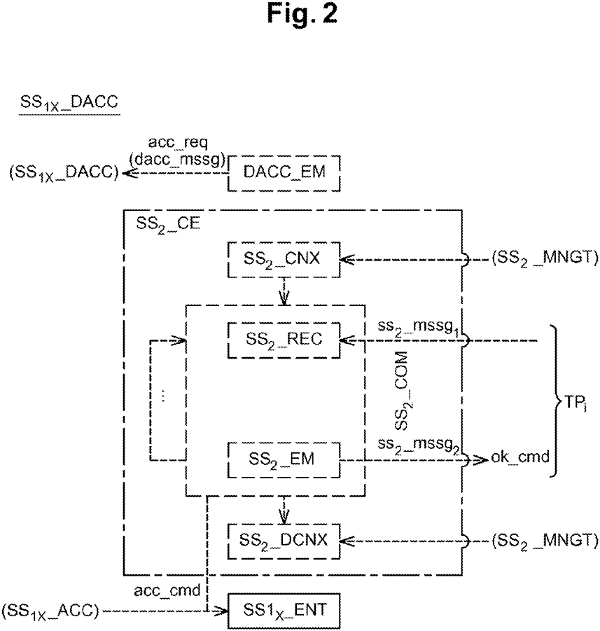

FIG. 2 illustrates a simplified diagram of a method for requesting access to a first secure communication session by a requesting terminal according to the invention.

The access request method SS_{1X}_DACC is a method for requesting access to a first secure communication session, called first session, ongoing between participating communication terminals TPᵢ, called participating terminals, by a requesting communication terminal TR, called requesting terminal. The access request method SS_{1X}_DACC comprises:
admitting SS_{1X}_ENT the requesting terminal TR into the first ongoing session SS_{1X}, which admission is triggered acc_cmd upon receipt of an acceptance from one of the participating terminals following the transmission of an access request message dacc_mssg sent by the requesting terminal TR to at least one participating terminal TPᵢ of the first session.

In particular, the access request method SS_{1X}_DACC comprises:
sending DACC_EM an access request acc_req from the requesting terminal TR to at least one participating terminal participating in the first session SS_{1X}, with the access request acc_req comprising the access request message dacc_mssg.

In particular, sending DACC_EM the access request message to the at least one terminal participating in the first session SS_{1X} comprises:
broadcasting the message to all the participating terminals before the requesting terminal accesses the first session.

In an alternative embodiment, sending DACC_EM the access request message to the at least one participating terminal of the first session SS_{1X} comprises:
sending the message via asynchronous communication to at least one of the participating terminals.

In particular, sending DACC_EM the access request message to the at least one participating terminal of the first session SS_{1X}comprises:
sending the message to at least one participating terminal of the first session outside the first session.

In particular, the access request message dacc_mssg comprises at least one datum from among the following data:
a short audible warning datum, in particular a jingle, a bell, a warning tone, etc., such as an entrance gong, a doorbell chime, an audio datum corresponds to a “knock knock” on a door, etc.;
an identifier associated with the requesting terminal, such as a telephone number, an IMEI identifier, etc., a name, pseudonym or an email address of a user of the requesting terminal, etc.;
an identifier associated with a terminal participating in the secure communication session;
an identifier of the first session to which the requesting terminal requests access;
a text, audio or video message of a user of the requesting terminal.

In particular, the access request method SS_{1X}_DACC comprises:
connecting SS₂_CNX the requesting terminal TR, before the admission SS_{1X}_ENT of the requesting terminal TR into the first session SS_{1X}, to a second synchronous communication session SS₂ established with one of the participating terminals TPᵢ participating in the first session following the transmission DACC_EM of the access request message sent by the requesting terminal to at least one participating terminal of the communication session.

Then, the access request method SS_{1X}_DACC particularly comprises implementing a communication SS₂_COM via the second session SS₂ between the participating terminal TPᵢ and the requesting terminal TR. They can thus particularly exchange messages SS₂_mssg₁, SS₂_mssg₂, etc. By virtue of these exchanges, the participating terminal TPᵢ and/or the user of the participating terminal TPᵢ can request additional information from the requesting terminal TR and/or from the user of the requesting terminal TR. For example, when only the telephone number of the requesting terminal is provided by the access request message dacc_mssg, the participating terminal TPᵢ and/or its user can request the name of the user of the requesting terminal and any other information concerning the requesting terminal (technical capabilities, for example, in order to check its compatibility for accessing all or part of the first session: content, type of video communication, etc.) or concerning the user of the requesting terminal (affiliation with a school, an educational level, a company, a team, etc.; skills; age, etc.). The additional information will enable the user of the participating terminal TPᵢ or the participating terminal to implement a decision-making method for accepting or not accepting the access request from the requesting terminal.

In particular, the access request method SS_{1X}_DACC comprises:
disconnecting SS₂_DCNX the requesting terminal from the second session as soon as the second session is closed by a method SS₂_MNGT for managing the second session following:
   acceptance OK_REC of admission of the requesting terminal TR into the first session SS_{1X} by the participating terminal TPᵢ of the second session SS₂;
   admitting ENT_TRG the requesting terminal TR into the first session SS_{1X}.

In particular, the access request method SS_{1X}_DACC comprises participating, as a caller SS₂_CE, in a second communication session, called second session, separate from the first session. The second session SS₂ allows the requesting terminal TR to exchange with at least one participating terminal TPᵢ participating in the first session. Participating in a second session as a caller SS₂_CE particularly comprises implementing the communication SS₂_COM, via the second session SS₂, between the participating terminal TPᵢ and the requesting terminal TR.

In particular, participating in a second session as a caller SS₂_CE comprises connecting SS₂_CNX and/or disconnecting SS₂_DCNX the requesting terminal TR to/from the second session SS₂.

In particular, the steps of participating in a second session as a caller SS₂_CE are implemented by the access request method SS_{1X}_DACC.

After admission SS_{1X}_ENT of the requesting terminal TR into the first session SS_{1X}, the requesting terminal TR accesses the first session SS_{1X}. The participating terminals TP₁, {TPₙ}ₙ and the requesting terminal TR accessing the first session SS_{1X} exchange data, such as text messages, audio and/or video communications, content, etc., via this first session SS_{1X}.

In a particular embodiment, the admission SS_{1X}_ENT of a requesting terminal TR results from an acceptance acc_cmd by a participating terminal TPᵢ after an access request message dacc_mssg is sent by the requesting terminal TR.

In particular, the access request method SS_{1X}_DACC comprises sending DACC_EM an access request acc_reg(dacc_mssg) from the requesting terminal to at least one participating terminal TPᵢ, in particular via the access method SS_{1X}_ACC.

Alternatively, subject to the requesting terminal TR knowing at least one participating terminal TPᵢ or a participating user UPᵢ (provided with a participating terminal TPᵢ) participating in the first session SS_{1X}, the access request acc_req is sent directly from the requesting terminal TR to the participating terminal TPᵢ or to the participating user UPᵢ (provided with a participating terminal TPᵢ). Furthermore, the participating terminal TPᵢ accepting the access request directly or indirectly (in particular via the access method SS_{1X}_DACC) commands ok_cmd the admission of the requesting terminal TR into the first session SS1X_ENT.

In particular, the admission SS_{1X}_ENT is directly commanded acc_cmd by the participating terminal TPᵢ. Alternatively, the access method SS_{1X}_ACC receiving an acceptance ok_cmd from the participating terminal TPᵢ commands acc_cmd the admission SS_{1X}_ENT.

In a particular embodiment, optionally supplementing the previous specific embodiment, the one or more participating terminal(s) TPᵢ that received the access request message dacc_mssg from the requesting terminal TR can synchronously or asynchronously exchange with the requesting terminal TR prior to the acceptance triggering the admission command acc_cmd. The requesting terminal TR can particularly receive SS₂_REC a first message mssg1 from the one or more participating terminal(s) TPᵢ, in particular via a second session SS₂, the first message mssg1 is then, for example, relayed from the participating terminal TPᵢ to the requesting terminal TR by the method SS₂_MNGT for managing the second session.

In particular, the first message mssg1 comprises a request relating to the requesting terminal TR, in particular to its capabilities in terms of peripherals (camera, microphone, screen size, etc.), in terms of memory, in terms of processing (software, plug-in, etc.), etc., and/or to the user of the requesting terminal (identity, location, age, skill(s), skill(s) level, etc.). In this case, the requesting terminal TR can send SS₂_EM a second message mssg2 in return or in response that particularly comprises one or more response(s) to the requests of the first message mssg1, in particular via the second session SS₂ if the first message mssg1 was transmitted thereby, the second message mssg2 is then, for example, relayed from the requesting terminal TR to the participating terminal TPᵢ by the method SS₂_MNGT for managing the second session. The exchange can continue with additional messages between the one or more participating terminal(s) TPᵢ and the requesting terminal TR. In particular, the exchange is particularly closed by the acceptance command acc_cmd by one of the participating terminals TPᵢ exchanging with the requesting terminal TR.

In particular, one of the messages mssg originating from the participating terminal TPᵢ comprises the acceptance command acc_cmd, ok_cmd. In this latter case, the requesting terminal TR commands acc_cmd its admission SS_{1X}_ENT into the first session by sending the acceptance command acc_cmd, ok_cmd contained in the received message mssg either directly to the admission SS1X_ENT or to the access method SS_{1X}_ACC.

A particular embodiment of the access request method SS_{1X}_DACC is a program comprising program code instructions for executing the steps of the access request method SS_{1X}_DACC when said program is executed by a processor.

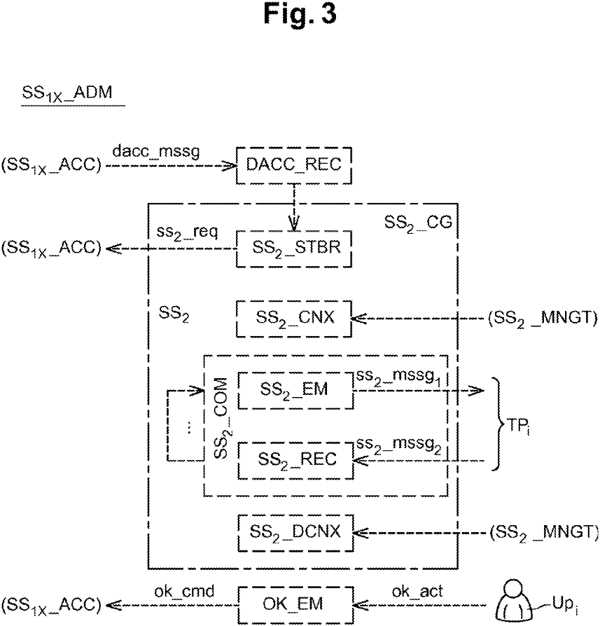

FIG. 3 illustrates a simplified diagram of a method for granting access to a first secure communication session by a requesting terminal according to the invention.

The method SS_{1X}_ADM for granting access grants access to a first secure communication session SS_{1X}, called first session, ongoing between participating communication terminals TPₙ, called participating terminals, by a requesting communication terminal TR, called requesting terminal. The method SS_{1X}_ADM for granting access comprises:
sending OK_EM an acceptance from one of the participating terminals TPᵢ upon receipt of an access request message dacc_mssg from the requesting terminal TR that is received by at least one participating terminal TPᵢ of the first session, with the sent acceptance ok_cmd triggering, upon receipt, admission of the requesting terminal into the first ongoing session.

In particular, the method SS_{1X}_ADM for granting access comprises:
receiving DACC_REC an access request message dacc_mssg from a requesting terminal TR. In particular, reception DACC_REC involves receiving an access request acc_req comprising the access request message dacc_mssg. Optionally, the access request message dacc_mssg is relayed by an access method SS_{1X}_ACC, for example, as described with reference to FIG. 1b.

In particular, the access request message dacc______mssg comprises at least one datum from among the following data:
a short audible warning datum, in particular a jingle, a bell, a warning tone, etc., such as an entrance gong, a doorbell chime, an audio datum corresponds to a “knock knock” on a door, etc.;
an identifier associated with the requesting terminal, such as a telephone number, an IMEI identifier, etc., a name, pseudonym or an email address of a user of the requesting terminal, etc.;
an identifier associated with a terminal participating in the secure communication session;
an identifier of the first session to which the requesting terminal requests access;
a text, audio or video message of a user of the requesting terminal.

In particular, sending OK_EM the acceptance is activated ok_act by the participating user UPᵢ with the participating terminal TPᵢ implementing the method SS_{1X}_ADM for granting access.

By way of an example, the access request message dacc_mssg comprises an entrance gong and the name of the requesting user UR of the requesting terminal TR. The access request message dacc_mssg will be reproduced by the participating terminal TPᵢ. Furthermore, the participating user UPᵢ with the participating terminal TPᵢ will perform an approval action ok_act: oral approval, pressing an OK key on a physical or virtual keyboard, nodding of the head. The method SS_{1X}_ADM for granting access optionally comprises detecting UP_CPT the approval action ok_act that activates sending of the acceptance OK_EM.

In particular, the method SS_{1X}_ADM for granting access comprises:
requesting SS₂_STBR the establishment, before triggering ENT_TRG admission of the requesting terminal TR into the first session SS_{1X}, of a second session SS₂ of synchronous communication between the requesting terminal TR and one of the participating terminals TPᵢ participating in the first session following an establishment request ss₂_req from said one of the participating terminals TPᵢ after receiving DACC_REC the access request message sent by the requesting terminal TR.

Then, the method SS_{1X}_ADM for granting access particularly comprises implementing a communication SS₂_COM via the second session SS₂ between the participating terminal TPᵢ and the requesting terminal TR. They thus can particularly exchange messages SS₂_mssg₁, SS₂_mssg₂, etc. By virtue of these exchanges, the participating terminal TPᵢ and/or the user of the participating terminal TPᵢ can request additional information from the requesting terminal TR and/or from the user of the requesting terminal TR. The additional information will enable the user of the participating terminal TPᵢ or the participating terminal to implement a decision-making method for accepting or not accepting the access request from the requesting terminal.

In particular, the method SS_{1X}_ADM for granting access comprises:
disconnecting SS₂_DCNX the participating terminal TPᵢ from the second session SS₂ once a step from among the following steps is implemented by the access method SS_{1X}_ACC:
   receiving OK_REC an acceptance by the participating terminal TPᵢ of the second session SS₂;
   triggering ENT_TRG the admission of the requesting terminal TR into the first session SS_{1X}.

In particular, the method SS_{1X}_ADM for granting access comprises participating, as a caller SS₂_CG, in a second communication session, called second session, separate from the first session. The second session SS₂ allows the participating terminal TPᵢ to exchange with the requesting terminal. Participating in a second session as a caller SS₂_CG particularly comprises implementing the communication SS₂_COM, via the second session SS₂, between the participating terminal TPᵢ and the requesting terminal TR.

In particular, participating in a second session as a caller SS₂_CG comprises requesting the establishment SS₂_STBR of the second session and/or disconnecting SS₂_DCNX the participating terminal TPᵢ from the second session.

In particular, the steps of participating in a second session as a caller SS₂_CG are implemented by the method SS_{1X}_ADM for granting access.

After sending OK_EM the acceptance triggering ENT_TRG, by means of the access method SS_{1X}_ACC, admission of the requesting terminal TR into the first session SS_{1X}, the requesting terminal TR accesses the first session SS_{1X}. The participating terminals TP₁, {TPₙ}ₙ and the requesting terminal TR accessing the first session SS_{1X} exchange data such as text messages, audio and/or video communications, content, etc., via this first session SS_{1X}.

Triggering ENT_TRG the admission of a requesting terminal TR that is implemented by the access method SS_{1X}_ACC results from a participating terminal TPᵢ sending OK_EM an acceptance ok_cmd that is received, particularly by the access method SS_{1X}_ACC, after an access request message dacc_mssg is sent by the requesting terminal TR.

In particular, the method SS_{1X}_ADM for granting access comprises receiving DACC_REC an access request message dacc_mssg from a requesting terminal TR, particularly in the form of an access request acc_req(dacc_mssg) from the requesting terminal comprising the access request message dacc_mssg.

In particular, the access request message dacc_mssg received DACC_REC by the method SS_{1X}_ADM for granting access is sent by an access request method SS_{1X}_DACC, as is particularly described with reference to FIG. 2, and is relayed (i.e., received from the requesting terminal, then sent to at least one participating terminal TPᵢ) by an access method SS_{1X}_ACC, as is particularly described with reference to FIG. 1b.

Alternatively, subject to the requesting terminal TR knowing at least one participating terminal TPᵢ or a participating user UPᵢ (provided with a participating terminal TPᵢ) participating in the first session SS_{1X}, the access request acc_req is directly received DACC_REC by the participating terminal TPᵢ from the requesting terminal TR. Furthermore, the participating terminal TPᵢ accepting the access request directly or indirectly commands ok_cmd the triggering ENT_TRG, by the access method SS_{1X}_ACC, of the admission of the requesting terminal TR into the first session SS_{1X}.

In particular, the triggering ENT_TRG is directly commanded ok_ cmd by the participating terminal TP; by sending OK_EM the acceptance to the access method SS_{1X}_ACC. Alternatively, the access method SS_{1X}_ACC comprises receiving OK_REC an acceptance ok_cmd from the participating terminal TPᵢ. The reception of an acceptance OK_REC commands ent_ok_ the triggering of admission into the first session ENT_TRG.

Optionally, the acceptance OK_EM comprises, in addition to validating ok_cmd(SS_{1X}, TR) the admission of the requesting terminal into the first session SS1X (for example, in the form of an identifier associated with the requesting terminal and, optionally, of an identifier of the first session), data relating to the granted access ok_cmd(SS_{1X}, TR, acc_ty_{TR}). For example, access acc_t_{YTR} to the first session SS_{1X} for the requesting terminal TR can be:
total, i.e., identical to the accesses granted to the other participants;
access with a predefined category, such as the guest category, or n^{th} category (in particular when the participants are themselves already divided into several categories for different forms of access: access by:
   text and/or audio and/or video exchanges; and/or
   reading, and/or writing content; and/or
   sharing or not sharing content);
limited (access by text exchange only, and listening/viewing the exchanges of the participating terminals and/or read access to the shared content, without document sharing by the requesting terminal), etc.

In a particular embodiment, optionally supplementing the previous specific embodiment, the participating terminal TPᵢ that received the access request message dacc_mssg from the requesting terminal TR can synchronously or asynchronously exchange with the requesting terminal TR before sending OK_EM the acceptance ok_cmd. The participating terminal TPᵢ can particularly send a first message mssg1 to the requesting terminal.

In particular, the first message mssg1 of the participating terminal TPᵢ comprises a request relating to the requesting terminal TR, in particular to its capabilities in terms of peripherals (camera, microphone, screen size, etc.), in terms of memory, in terms of processing (software, plug-in, etc.), etc., and/or to the user of the requesting terminal (identity, location, age, skill(s), skill(s) level, etc.). In this case, the requesting terminal TR can send a second message mssg2 in return or in response that particularly comprises one or more response(s) to the requests of the first message mssg1. The exchange can continue with additional messages between the participating terminal TPᵢ and the requesting terminal TR. In particular, the exchange is particularly closed by the acceptance ok_cmd by the participating terminal TPᵢ exchanging with the requesting terminal TR.

In particular, one of the messages mssg originating from the participating terminal TPᵢ comprises the acceptance command ok_ cmd. In this latter case, the requesting terminal TR commands ok_cmd the triggering ENT_TRG of its admission into the first session by sending the acceptance command contained in the first message mssg1 to the access method SS_{1X}_ACC.

A particular embodiment of the method SS_{1X}_ADM for granting access is a program comprising program code instructions for executing the steps of the method SS_{1X}_ADM for granting access when said program is executed by a processor.

In a particular embodiment of the invention, the invention relates to a program comprising program code instructions for executing the steps of the method for accessing a first secure communication session and/or the method for requesting access and/or the method for granting access when said program is executed by a processor.

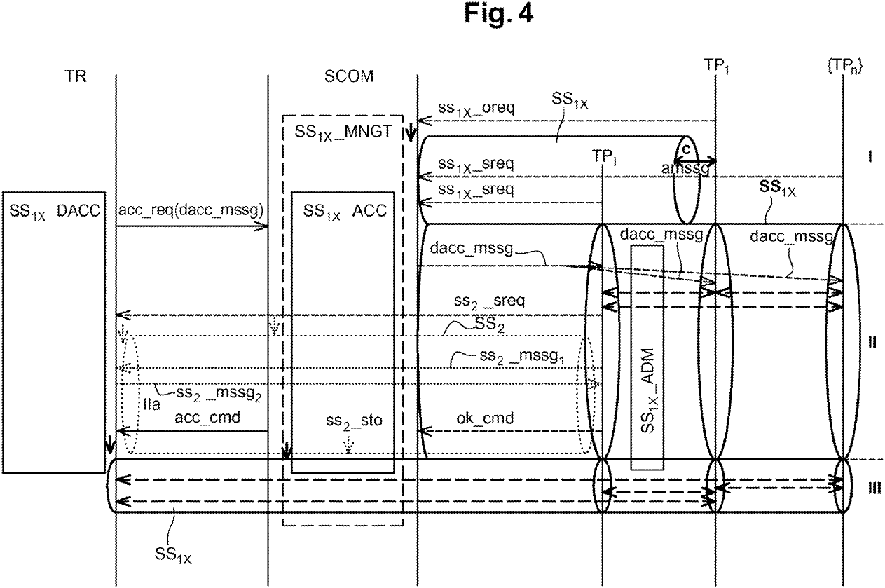

FIG. 4 illustrates a simplified diagram of a diagram of exchanges in a communication architecture implementing a method for accessing a first secure communication session by a requesting terminal according to the invention.

The embodiment of FIG. 4 makes provision for the use of a communication server SCOM implementing an access method SS1X_ACC according to the invention, in particular an access method SS1X_ACC as illustrated in FIG. 1b and_{/}or an access management method SS1X_MNGT optionally implementing the access method SS1X_ACC. The communication server SCOM is or comprises a management device separate from the participating terminals TPₙ participating in the first secure communication session SS_{1X} and the requesting communication terminal TR.

A first secure communication session SS_{1X} is established by the communication server SCOM (as shown in phase 1 of FIG. 4). In particular, the access management method SS_{1X}_MNGT by the communication server SCOM comprises establishing the first secure communication session SS_{1X}. Optionally, the first secure communication session SS_{1X} is established following a request ss_{1X}_oreq to establish the first session originating from a participating terminal: the first participating terminal TP₁ in the case of FIG. 4. The first participating terminal TP₁ is particularly an administrator communication terminal of the first session, i.e., the communication terminal that defined a list of the participants in the first session SS_{1X} and/or the one or more type(s) of access authorized for at least one of the participants (the same type of predefined access that can be authorized for one or more or even all the participants).

The first terminal TP₁ with access to the first session SS_{1X} can prepare the work contemplated for the first session, for example, by sharing content c and/or by filing a message for welcoming the other participants.

At any time during the first session SS_{1X}, at least one of the participating terminals TPᵢ, {TPₙ} (separate from the first terminal in the example of FIG. 4) requests ss₁ₓ_sreq secure access to the first session from the communication server SCOM.

In particular, the access management method SS1 X_MNGT checks AUTH_V whether the relevant participating terminal TPᵢ, {TPₙ} is authorized to access the first session SS1X before granting secure access SS1X_ACC to the first session SS1X to the participating terminal TPᵢ, {TPₙ} requesting this secure access. This authorization check AUTH_V particularly comprises at least one from among the following checking steps:
checking LST_V whether the relevant participating terminal TPᵢ, {TPₙ} is a terminal of the list of participants and/or is a terminal of the list of participants available to a user;
checking CDA_V whether the access code provided by the relevant participating terminal TPᵢ, {TPₙ} corresponds to an access code for accessing the first session.

The communication server SCOM grants secure access to the first session SS_{1X} to the relevant participating terminal TPᵢ, {TPₙ} (as shown in phase II of FIG. 4). The first terminal TP₁ and the other participating terminals TPᵢ, {TPₙ} with access to the first session SS_{1X} can then exchange with each other and/or share content according to the type of first communication session: telephone conference, and/or text conference or “chat room”, and_{/}or audio conference, and/or video conference, and/or collaborative space with read and/or write sharing of documents in particular.

During this first session SS_{1X}, a requesting terminal TR can request access to the first session at any time, in particular from the communication server SCOM, as illustrated in FIG. 4. To this end, it sends an access request message daccc_mssg, optionally in an access request acc_req. This sending of an access request message daccc_mssg by the requesting terminal particularly involves a step of an access request method SS1X_DACC (in particular as illustrated in FIG. 2) implemented by the requesting terminal.

The communication server SCOM receiving the access request message daccc_mssg transmits it to at least one participating terminal TP₁, TPᵢ, TPₙ. Optionally, receiving and then sending the access request message daccc_mssg to a participating terminal TP₁, TPᵢ, TPₙ is a step of an access method SS1X_ACC, in particular as illustrated in FIG. 1b, and/or an access management method SS1X_MNGT (optionally implementing steps of an access method SS1X_ACC) implemented by the communication server SCOM.

Following this request, at least one participating terminal TPᵢ can send an acceptance ok_cmd of this request to the communication server SCOM. Optionally, the participating terminal TPᵢ sending an acceptance to the communication server SCOM is a step of a method SS1X_ADM for granting access, in particular as illustrated in FIG. 3. In this case, the communication server SCOM commands access acc_cmd by the requesting terminal to the first session SS1X that triggers the admission of the requesting terminal TR into the first session SS1X (phase III illustrated in FIG. 4). The first terminal TP₁, the other participating terminals TPᵢ, {TPₙ} and the requesting terminal with access to the first session SS1X can then exchange with each other and_{/}or share content according to the type of first communication session and_{/}or their type of access.

Before the participating terminal TPᵢ sends an acceptance ok_cmd, the participating terminal can request SS_{2_}req, from the communication server SCOM, the establishment of a second communication session between the participating terminal TPᵢ and the requesting terminal TR. The communication server SCOM establishes the second session SS2. Thus, the participating terminal TPᵢ and the requesting terminal TR can exchange in order to particularly allow the participating terminal TPᵢ and/or its user UPᵢ to determine APV_DT whether or not the access by the requesting terminal to the first session is approved. The exchanges are particularly exchanges of messages SS₂_mssg₁, SS_{2_}mssg₂, etc. In particular, the communication server SCOM receiving the acceptance ok_cmd or the communication server SCOM triggering the admission of the requesting terminal TR closes ss₂_stp the second session.

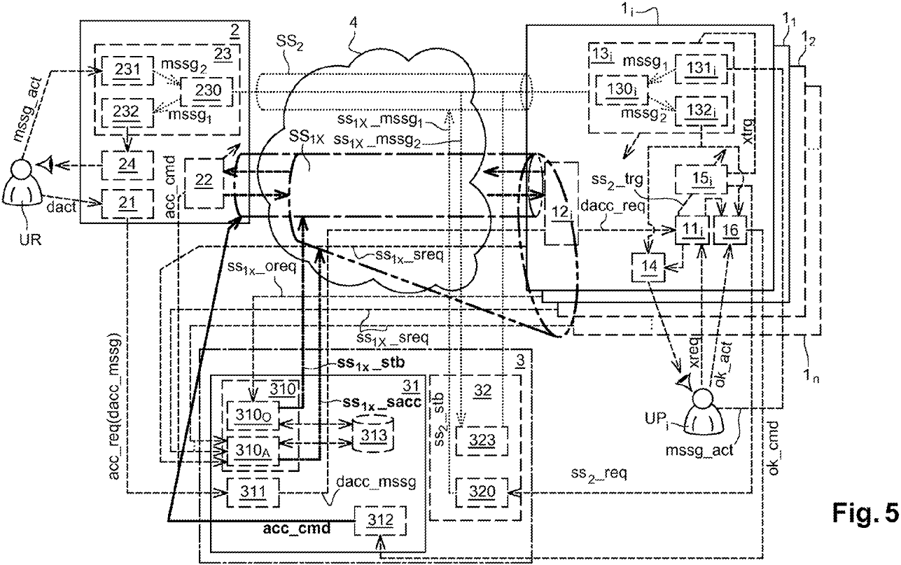

FIG. 5 illustrates a simplified diagram of a communication architecture comprising a device for managing access to a first secure communication session by a requesting terminal according to the invention.

The access management device 31 is capable of managing access to a first secure communication session, called first session, ongoing between participating communications terminals 1₁, 1n, 1i, called participating terminals, by a requesting communication terminal 2, called requesting terminal.

The access management device 31 comprises:
a controller 312 capable of triggering admission of the requesting terminal 2 into the first ongoing session upon receipt of an acceptance ok_cmd from one of the participating terminals 1₁.. 1n, 1i (terminal 1i in the example illustrated in FIG. 5) following the transmission of an access request dacc_msg sent by the requesting terminal 2 to at least one participating terminal 1₁.. 1n, 1i of the first session.

The communication architecture illustrated in FIG. 5 comprises:
a plurality of participating terminals 1₁, 1₂... 1n, 1i participating in the first secure communication session SS_{1X} via a communication network 4;
a communication terminal 2 requesting access to the first session SS_{1X}; and
an access management device 31.

In particular, the access management device 31 is implemented in a communication server, i.e., a device capable of managing at least one communication session via the communication network 4.

In particular, the access management device 31 is, or comprises, or is implemented in a device for managing a first secure communication session via the communication network 4. In the example of FIG. 5, the access management device implements a device for managing a first secure communication session 310.

In particular, the access management device 31 comprises a database of first secure sessions 313, in which lists of participants are recorded that are associated with first secure communication sessions. Optionally, predefined start and/or end dates and/or times of first secure sessions associated with a first session are also recorded in the database of first secure sessions 313.

In particular, the access management device 31 comprises a generator 310_{O} capable of establishing ss_{1X}_stb a first secure communication session SS_{1X}.

Optionally, the generator 310_{O} receives an establishment request ss_{1X}_oreq from a first participating terminal 1₁. Then, the generator 310_{O} is capable of establishing ss_{1X}_stb the first secure communication session SS_{1X} upon receipt of the establishment request ss_{1X}_oreq.

In particular, the access management device 31 comprises a connector 310_{A} capable of granting secure access ss_{1X}_sacc to the first secure communication session SS_{1X} to other participating terminals 1₂... 1n, 1i upon request for secure access ss_{1X}_sreq from these participating terminals 1₂... 1n, 1i. Then, at least one of the participating terminals particularly comprises a generator/transmitter of requests for establishing a first secure session (not shown). This is the case, in particular, of the first participating terminal 1₁ of FIG. 5. Furthermore, the participating terminals particularly comprise a generator/transmitter for requesting access to the first secure session (not shown). This is the case, in particular, of the other participating terminals 1₂... 1n, 1i of FIG. 5.

In particular, the management device 31 further comprises an access request relay 311 capable of transmitting an access request message dacc_mssg received from a requesting terminal 2 to at least one of the participating terminals 1₂... 1n, 1i. In particular, the relay comprises a receiver (not shown) for receiving an access request message dacc_mssg and/or an access request acc req originating from the requesting terminal, with the access request acc_req(dacc_mssg) comprising the access request message. Optionally, the relay comprises a transmitter (not shown) for sending an access request message dacc_mssg to at least one of the participating terminals 1₂... 1n, 1i via the first session SS_{1X} or outside, by synchronous, asynchronous or broadcast communication. The relay also particularly comprises an extractor (not shown) for extracting a message from a request that is capable of extracting an access request message dacc_mssg from an access request acc_req. The extractor is implemented between the request receiver and the access request message transmitter in order to provide the transmitter with the access request message extracted from the received access request.

FIG. 5 also shows a requesting communication terminal 2, called requesting terminal, capable of requesting access to a first secure communication session SS_{1X}, called first session, ongoing between participating communication terminals 1₁, 1₂... 1n, 1i, called participating terminals, by the requesting communication terminal 2, called requesting terminal. The requesting terminal 2 comprises:
a connector 22 capable of admitting the requesting terminal 2 into the first ongoing session SS_{1X}, the connector 22 being triggered acc_cmd upon receipt of an acceptance ok_cmd from one of the participating terminals 1i following the transmission of an access request dacc_mssg sent by the requesting terminal 2 to at least one participating terminal of the first session 1₁, 1₂... 1n, 1i.

In particular, the requesting terminal 2 comprises:
a generator 21 for generating an access request message dacc_mssg capable of being sent by the requesting terminal 2 to at least one participating terminal of the first session 1₁, 1₂...1n, 1i. Optionally, the generator 21 is capable of generating an access request acc_reg comprising the access request dacc_mssg. The generator 21 generates an access signal acc_sg, such as the access request message dacc_mssg or the access request acc req following an action dact by the requesting user UR.

In particular, the requesting terminal 2 comprises at least one output human-machine interface, called output interface, or reproduction means 24, such as a screen, at least one loudspeaker, etc., and/or at least one input or entry human-machine interface (not shown), called input interface, such as a keyboard, a mouse, a touch screen, a microphone, a camera, etc.

In the case whereby the generator 21 generates an access signal acc_sg following an action dact by the requesting user UR, the generator 21 receives data from an input interface relating to the action dact relating to this input interface of the requesting user UR. For example, the requesting user activates a warning button (similar to an entrance doorbell) on this input interface or strikes the touch screen in a manner similar to a knock on a door (“knock knock”).

FIG. 5 also illustrates participating communication terminals 1₁, 1₂...1n, 1i. A participating communication terminal 1₁, 1₂...1n, 1i, called participating terminal, is a communication terminal capable of accessing a first secure communication session SS_{1X}, called first session, ongoing between participating communication terminals 1₁, 1₂...1n, 1i, called participating terminals. A participating terminal 1₁, 1₂...1n, 1i comprises:
a connector 12i (shown in FIG. 5 only for the participating terminal 1i) capable of establishing the first session SS_{1X} between the participating terminal 1i and at least one other participating terminal 1₁, 1₂...1n;
a validator 16i (shown in FIG. 5 only for the participating terminal 1i) capable of accepting access ok_cmd to the first session SS_{1X} following the transmission of an access request dacc_mssg sent by the requesting terminal 2 to at least one participating terminal 1i of the first session, the validator 16i triggering admission acc_cmd of the requesting terminal 2 into the first ongoing session SS_{1X}.

In particular, the participating terminal 1i comprises a receiver 11i for receiving an access request message dacc_mssg originating from the requesting terminal 2 for access to the first session SS1X.

In particular, the participating terminal 1i comprises at least one output human-machine interface, called output interface, or reproduction means 14i, such as a screen, at least one loudspeaker, etc., and/or at least one input or entry human-machine interface (not shown), called input interface, such as a keyboard, a mouse, a touch screen, a microphone, a camera, etc.

The receiver 11i optionally provides the output interface 14i with the access request message dacc_mssg so that the access request message dacc_mssg can be perceived (read, heard, etc.) by the participating user UPᵢ of the participating terminal TPᵢ.

In particular, the validator 16i receives, directly or via an input interface (not shown) of the participating terminal TPᵢ, an acceptance action ok_act from the participating user UPᵢ in response, in particular to the access request message dacc_mssg made available to the participating user UPᵢ via the output interface 14i.

In particular, the participating terminal 1i comprises:
a connector 130i capable of establishing a second session SS₂ for synchronous communication with the requesting terminal 2 prior to the acceptance ok_cmd by the validator 16i.

In particular, the participating terminal 1i comprises a generator 15i for generating requests for establishing a second session ss_{2_}req. The generator 15i sends the request for establishing a second session ss_{2_}req to a device 32 for managing a second session, particularly implemented in a communication server 3. Thus, the device 31 for managing a first secure communication session and the device 32 for managing a second session can be implemented, for example, in a communication server 3.

In particular, the access management device 32 comprises a generator 320 capable of establishing ss_{2_}stb a second communication session SS₂ between the requesting terminal 2 and the participating terminal 1i.

In particular, the participating terminal 1i and the requesting terminal 2 each comprise a communication device, respectively 13i, 23, via the second session SS₂. The communication devices 13i, 23 comprise connectors 130i, 230 to the second session SS₂, and optionally transmitters 131i, 231 and_{/}or receivers 132i, 232, for example, for sending/receiving messages mssg₁, mssg₂, etc., which are sent via the second session SS₂ under the names of ss_{2_}mssg_{1,} ss₂₋mssg₂, etc.

In particular, the generator 15i for generating requests for establishing a second session SS₂ activates xtrg the communication device via the second session 13i of the participating terminal 1i.

In particular, the messages mssg₁, mssg₂, etc., transmitted via the second session are entered via the input interfaces 131i, 231, respectively, and are reproduced by the output interfaces 132i, 232, respectively, intended for the participating user UPᵢ and the requesting user UR, respectively.

In particular, the validator 16i comprises an analyzer capable of decision-making as a function of the access request message dacc_mssg, and/or of the messages exchanged via the second session ss2_mssg1, SS₂_mssg_{1,} etc., in particular those received from the requesting terminal 2, and/or of an action ok_act of the participating user UPᵢ of an acceptance of the requesting terminal 2 to access the first session SS_{1X}. In the case whereby the analyzer decides upon an acceptance, the validator 16i sends an acceptance ok_cmd to the device 31 for managing the first session, in particular to the controller 312.

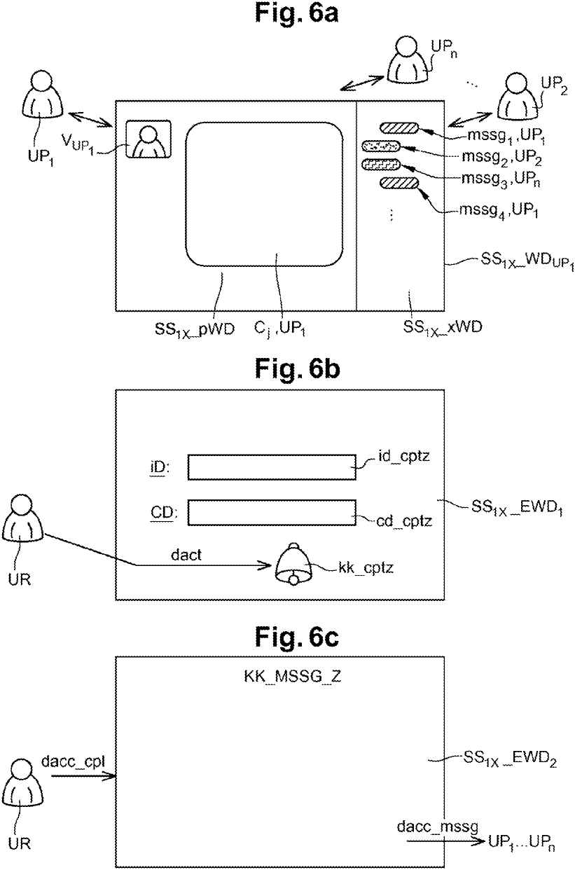

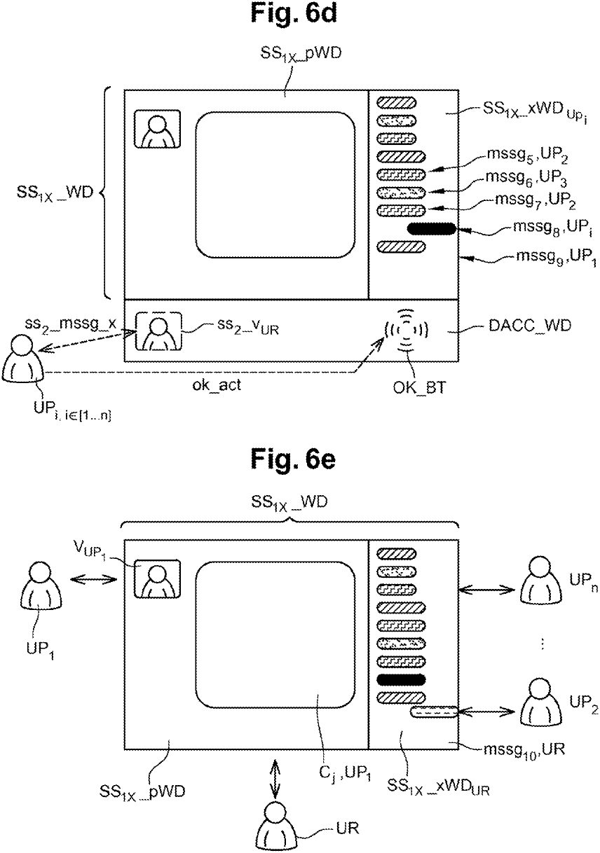

FIGS. 6a to 6e show a use of the invention in the case whereby the first secure session is a collaborative space comprising a text exchange space, a video conference and a space for sharing documents between participating users UP₁, UP₂... UPₙ, each provided with at least one participating communication terminal for accessing this collaborative space.

FIG. 6a shows a simplified diagram of the use of an access management method in a particular use case of the invention.

FIG. 6a shows a screen of the participating terminal of a first participating user UP₁.

The screen optionally comprises several windows, including one window associated with the first session SS_{1X}_WD and optionally divided into sub-windows:
a text exchange sub-window SS₁_{X}_XWD_{UP1}, in which the text messages exchanged by the various participants in the first session are reproduced, in particular in chronological order (in the example of FIG. 6a: the messages mssg1,UP1, MSsg4,UP1 from the first participating user, a message mssg_{2,UP2} from the second participating user, a message mssg_{3,UPn} from an n^{th} participating user, etc..); and/or
a sharing sub-window SS_{1X}_pWD, with the sharing sub-window SS_{1X}_pWD itself particularly comprising one or more sub-window(s), for example:
   a sub-window in which a video stream is reproduced, in this case the video stream of the first participating user UP₁; and/or
   a sub-window in which content is shared, in this case a j^{th} content C_{j,UP1} of the first participating user UP₁;
   etc.

FIG. 6b shows a simplified diagram of the use of an optional first step of an access request method according to the invention in the use case of the invention of FIG. 6a. FIG. 6a shows a screen of the requesting terminal of a requesting user UR. The requesting user is aware of the first session and, for example, enters an address of the first session (such as a url type address in their browser). Their screen then displays a first window SS_{1X}_EWD₁ for admission into the first session.

This first session admission window SS_{1X}_EWD₁ particularly comprises a zone for entering an identifier id_cptz of the requesting user UR and/or an identifier of their terminal and/or an area for entering an access code cd_cptz. With the requesting user UR not having the access code or not being included in the list of participants they cannot enter the requested identifier ID and/or access code CD in order to securely access the first session SS_{1X}.

The first session admission window SS_{1X}_EWD₁ particularly comprises a virtual warning button kk_cptz, on which the requesting user can act dact in order to transmit an access request message. In an alternative embodiment of the invention, not shown, with the requesting user UR having previously been identified as not belonging to the list of participants, the input window comprises only an interaction element, such as the virtual warning button kk_cptz, or the detection of a door knocking gesture, or the detection of a verbal interpellation, “Hello! Is anyone there?”, “Hello”, etc.

FIG. 6c shows a simplified diagram of the use of an optional second step of an access request method according to the invention in the use case of the invention of FIG. 6a.

Optionally, following the action of the requesting user dact with respect to the first session admission window SS_{1X}_EWD₁, a second admission window SS_{1X}_EWD₂ is reproduced allowing the requesting user UR to complete the access request message dacc_cpl. In particular, the requesting user can add their name, the reason for their access request, etc. Furthermore, the access request message dacc_mssg thus formed by the action dact of the user and/or a supplement dacc_cpl is sent from the requesting terminal to at least one participating terminal of one of the participating users U1... UPn.

FIG. 6d shows a simplified diagram of the use of a method for granting access according to the invention in the use case of the invention of FIG. 6a.

At least one of the participating terminals of the participating users UP1... UPn receives the access request message and reproduces it in an access request window DACC_WD. FIG. 6d shows the screen of the participating terminal of the participating user i UPᵢ. At this time, the exchanges continue compared to those shown in FIG. 6a: new messages are reproduced: mssg₅,_{UP2}, mssg_{6,UP3}, mssg_{7,UP2}, mssg_{8,UPi}, mssg_{9,UP1} in the text exchange sub-window SS_{1X}_xWD_{UPi}.

If the participating user i UPᵢ establishes a second session with the requesting terminal of the requesting user UR, the exchanges relating to this second session are reproduced in association with the access request window DACC_WD. For example, if these exchanges are voice exchanges, they will only be possible if the access request window DACC_WD is activated (for example, by selection by the participating user i UPᵢ). In another example, the exchanges are reproduced in text form in the access request window DACC_WD, at least if they are text exchanges, or even also by converting voice into text when they are voice and/or audio exchanges. In the example of FIG. 6d, a video stream originating from the requesting terminal of the requesting user SS₂_V_{UR} is reproduced. Thus, the requesting user UR has the impression of addressing a participating user as if they were doing so via a videophone or an intercom at the entrance of a secure room or a home.

The access request window DACC_WD comprises at least one interaction element OK_BT allowing the participating user UPᵢ to accept the access request of the requesting user. This interaction element is a physical or virtual acceptance button in particular, and/or a camera detecting a nodding head, and/or a microphone detecting an oral acceptance, etc.

FIG. 6e shows a simplified diagram of the use of an optional second step of an access request method according to the invention in the use case of the invention of FIG. 6a.

FIG. 6e shows a screen of the requesting terminal of the requesting user UR.

The screen optionally comprises several windows, including one window SS_{1X}_WD associated with the first session and optionally divided into sub-windows:
a text exchange sub-window SS_{1X}_XWD_{UR}, in which the text messages exchanged by the various participants in the first session are reproduced, in particular in chronological order (in the example of FIG. 6e: all the messages of the exchanges started in FIG. 6a and subsequently continued, in particular in FIG. 6d, including a message mssg10,UPR, MSsg4,UP1, etc., from the terminal requesting the first session SS_{1X}); and/or
a sharing sub-window SS_{1X}_pWD, with the sharing sub-window SS_{1X}_pWD itself particularly comprising one or more sub-window(s), for example:
   a sub-window in which a video stream is reproduced, in this case the video stream of the first participating user UP₁; and/or
   a sub-window in which content is shared, in this case a j^{th} content C_{j,UP1} of the first participating user UP₁;
   etc.

By using the invention, a requesting user aware of the location of the secure shared digital space (for example, the access url, the name of the virtual room, etc.), but who is not able to enter their identifiers and/or passwords due to forgetting or losing them, etc., is able to request access (especially in the form of a voice call, a sound, a touch, a visual call, etc.) to this space that they are seeking to join via a secure channel. This call, which is visible from within this space, allows any person already present to accept their admission into/their access to this space.

The invention is applicable to any secure shared digital space as long as this space requires an access key (in any form). Thus, only one person will need their key in order to access this space before confirming (by accepting ok_cmd) the access of the other participants one by one by recognizing them using their voice when the access request message comprises a voice message, their face when the access request message comprises a photo or a video of the requesting user, their access hardware, a secret question or any other recognition element.

The invention also relates to a medium. The information medium can be any entity or device capable of storing the program. For example, the medium can comprise a storage means, such as a ROM, for example, a CD-ROM or a microelectronic circuit ROM or even a magnetic recording means, for example, a floppy disk or a hard disk.

Moreover, the information medium can be a transmissible medium, such as an electrical or optical signal, which can be routed via an electrical or optical cable, by radio or by other means. The program according to the invention particularly can be downloaded over a network, in particular of the Internet type.

Alternatively, the information medium can be an integrated circuit, in which the program is incorporated, with the circuit being capable of executing or being used for executing the method in question.

In another implementation, the invention is implemented by means of software and/or hardware components. In this respect, the term module can equally correspond to a software component or to a hardware component. A software component corresponds to one or more computer program(s), one or more sub-program(s) of a program, or more generally to any element of a program or software capable of implementing a function or a set of functions according to the above description. A hardware component corresponds to any element of a hardware assembly (or hardware) capable of implementing a function or a set of functions.

Although the present disclosure has been described with reference to one or more examples, workers skilled in the art will recognize that changes may be made in form and detail without departing from the scope of the disclosure and/or the appended claims.

1. A method for accessing a first secure communication session, called first session, ongoing between participating communication terminals, called participating terminals, by a requesting communication terminal, called requesting terminal, the method being implemented by a management device and comprising:
triggering admission of the requesting terminal into the first ongoing session upon receipt of an acceptance from one of the participating terminals following a transmission of an access request message sent by the requesting terminal to at least one participating terminal of the first session.

2. The method for accessing a first secure communication session as claimed in claim 1,
wherein the requesting terminal is separate from the participating terminals associated with the first session.

3. The method for accessing a first secure communication session as claimed in claim 1,
wherein the access request message, which once transmitted triggers access to the first session, comprises data entered by using the requesting terminal.

4. The method for accessing a first secure communication session as claimed in claim 3, wherein sending the access request message to the at least one participating terminal of the first session comprises one of the following steps:
broadcasting the message to all the participating terminals before the requesting terminal accesses the first session;
sending the message via asynchronous communication to at least one of the participating terminals;
sending the message to at least one participating terminal of the first session outside the first session.

5. The method for accessing a first secure communication session as claimed in claim 1, the access request message comprising at least one datum from among the following data:
a short audible warning datum;
an identifier associated with the requesting terminal;
an identifier associated with a terminal participating in the secure communication session;
an identifier of the first session to which the requesting terminal requests access;
a text, audio or video message of a user of the requesting terminal.

6. The method for accessing a first secure communication session as claimed in claim 1, the method comprising:
establishing, prior to triggering admission of the requesting terminal into the first session, a second synchronous communication session between the requesting terminal and one of the terminals participating in the first session following an establishment request from said one of the participating terminals following the transmission of the access request sent by the requesting terminal to at least one participating terminal participating in the communication session.

7. The method for accessing a first secure communication session as claimed in claim 6, the method comprising:
closing the second session upon implementing one step from among the following steps:
receiving an acceptance by the participating terminal of the second session;
triggering admission of the requesting terminal into the first session.

8. Amethod for requesting access to a first secure communication session, called first session, ongoing between participating communication terminals, called participating terminals, by a requesting communication terminal, called requesting terminal, the method being implemented by the requesting terminal and comprising:
receiving an acceptance from one of the participating terminals following transmission of an access request sent by the requesting terminal to at least one participating terminal of the first session; and
admitting the requesting terminal being into the first ongoing session, with said admission being triggered upon receipt of the acceptance.

9. A method for granting access to a first secure communication session, called first session, ongoing between participating communication terminals, called participating terminals, by a requesting communication terminal, called requesting terminal, the method for granting access comprising:
sending an acceptance from one of the participating terminals upon receipt of an access request message from the requesting terminal that is received by at least one participating terminal of the first session, with the sent acceptance triggering, upon receipt, admission of the requesting terminal into the ongoing first session.

10. A non-transitory computer readable medium comprising a program recorded thereon comprising program code instructions for executing the method for accessing a first secure communication session as claimed in claim 1 when said program is executed by a processor.

11. A device for managing access to a first secure communication session, called first session, ongoing between participating communication terminals, called participating terminals, by a requesting communication terminal, called requesting terminal, the device comprising:
a processor; and
a non-transitory computer readable medium comprising instructions stored thereon which when executed by the processor configure the device to perform a method comprising:
triggering admission of the requesting terminal into the first ongoing session upon receipt of an acceptance from one of the participating terminals following transmission of an access request sent by the requesting terminal to at least one participating terminal of the first session.

12. A requesting communication terminal, called requesting terminal, capable of requesting access to a first secure communication session, called first session, ongoing between participating communication terminals, called participating terminals, by the requesting communication terminal, called requesting terminal, the requesting terminal comprising:
a processor; and
a non-transitory computer readable medium comprising instructions stored thereon which when executed by the processor configure the requesting terminal to perform a method comprising:
admitting the requesting terminal into the first ongoing session, the admitting being triggered upon receipt of an acceptance from one of the participating terminals following the transmission of an access request sent by the requesting terminal to at least one participating terminal of the first session.

13. The requesting terminal as claimed in the claim 12, the
wherein the instructions further configure the requesting terminal to generate the access request message to be sent by the requesting terminal to at least one participating terminal of the first session.

14. A participating communication terminal, called participating terminal, participating in a first secure communication session, called first session, ongoing between participating communication terminals, called participating terminals, the participating terminal comprising:
a processor; and
a non-transitory computer readable medium comprising instructions stored thereon which when executed by the processor configure the participating terminal to perform a method comprising:
establishing the first session between the participating terminal and at least one other of the participating terminals;
accepting access to the first session following the-transmission of an access request sent by the requesting terminal to at least one participating terminal of the first session, and triggering admission of the requesting terminal into the ongoing first session.

15. The participating terminal as claimed in claim 14,
wherein the instructions further configure the participating terminal to establish a second synchronous communication session with the requesting terminal prior to accepting access to the first session.

16. The method for accessing a first secure communication session as claimed in claim 1, the method comprising:
receiving the acceptance from a participating terminal of the first session.

17. The method for accessing a first secure communication session as claimed in claim 1, wherein the management device is implemented:
by a device that is separate from the participating terminals; or
by a device that is implemented in a participating terminal of the first session.

18. A non-transitory computer readable medium comprising a program recorded thereon comprising program code instructions for executing the method for requesting access as claimed in claim 8 when said program is executed by a processor.

19. A non-transitory computer readable medium comprising a program recorded thereon comprising program code instructions for executing the method for granting access as claimed in claim 9 when said program is executed by a processor.
